(19) United States
(12) Patent Application Publication
(10) Pub. No.: US 2014/0289007 A1
(43) Pub. Date: Sep. 25, 2014

(54) SCENARIO BASED CUSTOMER LIFETIME VALUE DETERMINATION

(71) Applicant: TATA CONSULTANCY SERVICES LIMITED, Mumbai (IN)

(72) Inventors: Soumya Narayan BHATTACHARYA, Bangalore (IN); Rajeev AIRANI, Bangalore (IN)

(73) Assignee: TATA CONSULTANCY SERVICES LIMITED, Mumbai (IN)

(21) Appl. No.: 14/199,196

(22) Filed: Mar. 6, 2014

(30) Foreign Application Priority Data
Mar. 21, 2013 (IN) 973/MUM/2013

(51) Int. Cl. G06Q 30/02

(52) U.S. Cl. CPC G06Q 30/0202
USPC 705/7.31

(57) ABSTRACT

A method and system for determining customer lifetime value (CLV) for a business is described. The method may include receiving, from a user, inputs associated with a plurality of parameters. The plurality of parameters correspond to customer transactions. The method may further include determining, based on the received inputs, a CLV base model applicable for the business. The CLV base model is determined from amongst a plurality of pre-defined CLV base models. Further, the method may include identifying at least one market scenario from amongst a plurality of pre-configured market scenarios for the business. Each of the plurality of pre-configured market scenarios are based on a combination of the plurality of parameters. The method may also include computing a consolidated CLV for the business based on the determined CLV base model and the at least one identified CLV scenario model.

### TECHNICAL FIELD

The present subject matter relates, in general, to customer lifetime value determination and, in particular, to determining customer lifetime value based on market scenarios.

### BACKGROUND

Customer lifetime value (CLV) is widely used as a metric to assess customer value and develop marketing plans to acquire, grow, and retain customers in a business. The CLV can be understood as the prediction of net profit attributable to the entire future relationship with a customer. Hence, the CLV tends to place greater emphasis on customer service and long-term customer satisfaction. Further, the CLV is useful for forecasting future sales and profits and thereby controlling costs and utilizing resources in a business efficiently.

Organizations with limited resources would ideally like to invest in those customers who bring maximum returns to the organizations. Typically such organizations employ CLV frameworks for determining customer specific business strategies. The CLV frameworks assist in identifying the CLV for all the customers and profiling the customers on the basis of their contribution to an organization's profits. This can be the basis for formulating and implementing customer specific strategies for maximizing lifetime profits of the organization. Once the organization has calculated the CLV of its customers, the organization may allocate the limited resources to achieve maximum return. Hence, optimal allocation of resources, such as for customer acquisition and retention, can depend, in a large part, on the calculated CLV.

### SUMMARY

This summary is provided to introduce concepts related to scenario based customer lifetime value determination and the concepts are further described below in the detailed description. This summary is neither intended to identify essential features of the claimed subject matter nor is it intended for use in determining or limiting the scope of the claimed subject matter.

In an embodiment, method(s) and system(s) for determining customer lifetime value (CLV) for a business are described. The method may include receiving, from a user, inputs associated with a plurality of parameters. The plurality of parameters may correspond to customer transactions. The method may further include determining, based on the received inputs, a CLV base model applicable for the business. The CLV base model is determined from amongst a plurality of pre-defined CLV base models. Further, the method may include identifying at least one market scenario from amongst a plurality of pre-configured market scenarios for the business. The identifying is based on a combination of the plurality of parameters applicable for the business. Further, a CLV scenario model is identified corresponding to the identified market scenario. The method may also further include computing a consolidated CLV for the business based on the determined CLV base model and the at least one identified CLV scenario model.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a customer lifetime value (CLV) framework, according to an implementation of the present subject matter.

FIG. 2 illustrates a network environment implementation of a CLV determination system, in accordance with an embodiment of the present subject matter.

FIG. 3a shows a flowchart illustrating a method for determining the CLV for a particular business, in accordance with an embodiment of the present subject matter.

FIG. 3b shows a flowchart illustrating a method for determining a CLV base model for a particular business, in accordance with an embodiment of the present subject matter.

FIG. 3c illustrates a method for determining a CLV scenario model for a particular business for potential customer value scenario, in accordance with an embodiment of the present subject matter

### DETAILED DESCRIPTION

The present subject matter relates to a system and a method for determining scenario based customer lifetime value.

Developing and maintaining profitable customer relationships is vital for every business. Generally, customer lifetime value (CLV) is calculated and used to implement customer level business strategies. The CLV may be understood as a metric that may predict future profitability of a customer for an organization. The CLV calculates the value of the customer relationship with the organization for a specific time frame. Based on past history of the customer, the CLV may predict the future relation of the customer with the organization. Organizations can use CLV to identify which customers are most likely to bring maximum profit to the organization in the future, what are the factors leading to higher CLV, and the optimal levels of resource allocation to various channels of communication. The CLV calculation itself depends on the nature of the business. For example, the CLV calculation for a consumer packaged goods (CPG) company would be different than the CLV calculation for a banking institution. However, existing CLV frameworks do not sufficiently take into account such differences for the CLV calculation.

Typically, the existing CLV frameworks, such as the CLV framework proposed by Fader and Hardie, classify various businesses based on contractual, non-contractual, continuous, and discrete dimensions. Accordingly, the CLV framework includes four groups of businesses, i.e., continuous and contractual, continuous and non-contractual, discrete and contractual, discrete and non-contractual. However, the existing CLV frameworks do not take into consideration any transactional or operational differences between businesses in the same group. As a result, while the CLV calculation considerations may differ for businesses that belong to the same group, the existing CLV frameworks can not handle such differences.

For example, as per the above-mentioned CLV framework, a magazine business and an insurance business may fall in the same group of continuous and contractual. However, both the businesses operate in different manner. In the magazine business, though the transactions occur multiple times during a contractual period, the actual CLV generating transaction occurs only once, at the beginning of a contract. On the other hand, in the insurance business, an insurance value is generated for a fixed contractual duration but the transactions are done regularly, say every month or every year. The premium payment or regular transaction is more important for the insurance business than for the magazine business, since all the money is not paid-up in advance to insurance providers. Therefore, the existing framework is not capable of distinguishing the businesses based on the operation and transaction models. From a business point of view, it may lead to sub-optimal business strategies being generated as business benefits and strategies will differ based on the operation and transaction models also.

Further, while organizations are interested in knowing the CLV of their customers, they are also keen on identifying the factors that affect the value of their customers. However, existing CLV frameworks do not take into consideration the factors that may impact the businesses and therefore the organizations are unable to take strategic decisions based on the impact of those factors on customer buying behaviour and in turn on the CLV.

In various implementations, the present subject matter describes system(s) and method(s) for determining customer lifetime value based on market scenarios. The present subject matter provides a framework for calculating the CLV based on different market scenarios. Further, the framework takes into account operational and transactional factors also. In one aspect, the framework is based on dimensions of time, count, and duration. Each dimension of the framework may be divided into at least two categories. The dimension of time represents the certainty of when the event generates value from a transaction. For example, for time, the categories in the framework may either be certain or uncertain. Further, the dimension of count represents how many times the value is generated and so, the dimension of count can be categorized as either high or low. In addition, the dimension of duration represents how long the value is generated and the framework is developed by considering the duration as either fixed or open. In another implementation, each dimension of the framework may include more than two categories based on the level of granularity that may be necessary for identifying a CLV model for calculation of the CLV.

Further, the framework may be configured to categorize different businesses using the dimensions in a manner such that businesses that follow similar CLV calculation models, or have similar CLV calculation considerations, are put together in one category. In an implementation, the framework may be configured to perform the categorization based on different combinations of the three dimensions, namely, time, count, and duration. This may facilitate in identifying a CLV calculation model to be used for determining the CLV for a business. Table 1 below provides an illustration of how the categorization is done based on the three dimensions, each dimension having 2 categories.

TABLE 1

| DIMENSIONS | DEFINITION | CATEGORY |
|---|---|---|
| Time | When an event generates | Certain/Uncertain |
| | value | |
| Count | How many times the value | High/Low |
| | is generated | |
| Duration | How long a business last | Open/Fixed |

Further, for each combination of the categories in the three dimensions, the framework defines a base model for CLV calculation. The framework therefore includes eight base models based on eight combinations of the categories in the three dimensions. Accordingly, the businesses that fall under one category in the framework will have one base model for calculating CLV.

In yet another implementation, the system of the present subject matter may facilitate in identifying different market scenarios that may impact the CLV for a business. The market scenarios can include: (1) potential customer value, (2) introduction of new product/services on CLV, (3) removal of existing product/services on CLV, (4) permanent change in product/services price, (5) permanent change in product/services attributes, (6) change in distribution/channels in CLV, and (7) Macro-economic changes. Here, potential customer value scenario refers to a scenario where there is a high probability that a customer buys new services/products which he does not use currently. Further, based on the above-mentioned seven market scenarios, the system may be configured to determine a best case CLV, a most probable CLV, and a worst case CLV. The system may be configured to identify the applicable market scenarios based on various competitive/internal/economic factors and user inputs.

Further, for each of the seven market scenarios, the framework employs at least one pre-defined CLV scenario model such that, for each business in each scenario, a consolidated CLV is computed based on a CLV base model that may be applicable for that business category and at least one CLV scenario model that may be associated with the scenario for the business category. The at least one CLV scenario model may include a Logit model, a Headroom analysis, a Customer loyalty model, a Market share model, a Nested Logit model, a Markov chain model, a Vector Auto-Regressive model, an Elasticity model, an Impulse response (IR) model, and a combination thereof.

Accordingly, the present subject matter provides an integrated framework that may facilitate in classifying different business based on the CLV calculations. Further, the framework includes eight CLV base models based on different combinations of the categories in the three dimensions that may facilitate in identifying a group to which a specific business belongs. Based on this, the CLV may be calculated for the business. Moreover, the framework facilitates in identifying different factors and market scenarios that impact the CLV of an organization. Therefore, the framework facilitates in drawing implications on the CLV from changing market scenarios.

These and other advantages of the present subject matter would be described in greater detail in conjunction with the following figures. While aspects of described systems and methods for determining customer lifetime value can be implemented in any number of different computing systems, environments, and/or configurations, the embodiments are described in the context of the following exemplary system(s).

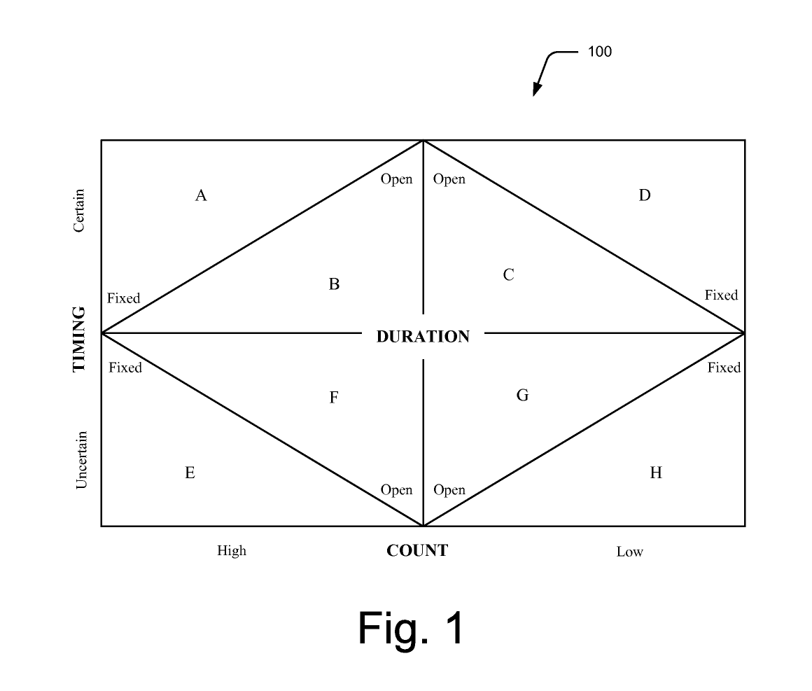

FIG. 1 illustrates a schematic view of a CLV classification framework 100, hereinafter referred as a framework 100, according to an implementation of the present subject matter. According to an aspect, the purpose of the framework 100 is to classify various businesses in different categories based on three parameters namely, time, count, and duration. The framework 100 classifies the different businesses in eight groups based on eight possible combinations of the two categories of the three parameters. For example, group A indicates a business type where transactions occur for a certain time period and for a fixed duration, and the number of transactions (count) is high. The framework 100 can thus categorize insurance business, credit card business, and pay day lending in Group A, based on the combination of the three parameters. Further, the framework 100 defines a base model for calculating the CLV for businesses falling in Group A. Likewise, the framework 100 can categorize regular health check-ups/disease monitoring and post-paid telecom services under Group B based on the consideration that transactions for these business types occur at a certain time period, on a regular basis, and there may not be any fixed duration for such transactions.

Group C indicates those business types, such as bank locker fee, for which the time is fixed and the transactions are not very frequent. Moreover, these business types may not be for a fixed duration. Further, Group D includes those business types, such as magazine subscription, for which transactions occur at a certain time but not frequently and for a fixed duration of time. Furthermore, Group E classifies those business types for which transactions occur at uncertain time intervals. The transactions may be high in count and for a fixed duration. Examples of such businesses may include but are not limited to, a trading account, and a wholesale club card. Group F includes business types, such as grocery, and pre-paid telecom services, where the time of transactions may be uncertain but high in count. The duration for the transactions for such businesses may not be fixed and therefore the businesses are categorized in Group F.

Group G includes business types, such as airlines, where the transactions may occur at uncertain timings, the count may be low, and the duration of such transactions may not be fixed. Consumer durables business falls under Group H of the framework 100. Group H businesses may occur at uncertain timings, the count may be low, but the duration of such transactions is fixed. Further, the framework 100 is configured to define different CLV base models for each of the eight groups based on the three parameters. Accordingly, the CLV for a business may be calculated by determining which combination of parameters will be suitable for the business.

Table 2 below provides an exemplary illustration of the CLV base models selected by the framework 100, in accordance with an implementation of the present subject matter. The table below indicates a list of different CLV base models for each group of business based on different combinations of the three parameters.

TABLE 2

| | DIMENSIONS | | | EXAMPLE | |
|---|---|---|---|---|---|
| GROUP | TIME | COUNT | DURATION | BUSINESS | BASE MODEL |
| A | Certain | High | Fixed | Insurance, Pay Day Lending, Credit Card | $CLV = {\sum }_{t = 0}^{T} \frac{{P}_{t}}{{( 1 + d )}^{t}} * {P}_{nf}$ |
| B | Certain | High | Open | Regular Monitoring Disease, Telecom (post-paid) | $CLV = {\sum }_{t = 0}^{∞} \frac{{P}_{t}}{{( 1 + d )}^{t}} * {P}_{h}$ |
| C | Certain | Low | Open | Bank Locker Fee | $CLV = {\sum }_{t = 0}^{∞} \frac{{P}_{t}}{{( 1 + d )}^{t}} * {P}_{h}$ |
| D | Certain | Low | Fixed | Magazine Subscription | $CLV = {\sum }_{t = 0}^{T} \frac{{P}_{t}}{{( 1 + d )}^{t}} * {P}_{nf}$ |
| E | Uncertain | High | Fixed | Wholesale club card, Trading account | $CLV = {\sum }_{t = 0}^{T} \frac{{P}_{t}}{{( 1 + d )}^{t}} * {P}_{np}$ |
| F | Uncertain | High | Open | Grocery, Telecom (pre-paid) | $CLV = {\sum }_{t = 0}^{∞} \frac{{P}_{t}}{{( 1 + d )}^{t}} * {P}_{np}$ |
| G | Uncertain | Low | Open | Airlines | $CLV = {\sum }_{t = 0}^{∞} \frac{{P}_{t}}{{( 1 + d )}^{t}} * ms$ |
| H | Uncertain | Low | Fixed | Consumer Durables | $CLV = {\sum }_{t = 0}^{T} \frac{{P}_{t}}{{( 1 + d )}^{t}} * ms$ |

where,
T = time frame of business from 0 to T
Pₜ = profit generated by customer in time t
d = discount rate
P_{nf} = probability of non-defaulter
Pₕ = hazard rate
Pₙₚ = probability of NBD/Pareto distribution
ms = market share of the product

As mentioned above, the framework 100 defines a CLV base model for each group. The CLV base model is a function of various variables that may be associated with a business. The variables may include a time frame of the business, profit generated by a customer at a time instance, discount rate, hazard rate, probability of a non-defaulter, probability of negative binomial distribution (NBD)/Parteo distribution, and market share of a product.

Further, the framework 100 may facilitate in identifying the CLV scenario model for a business in different market scenarios. The different scenarios may include competitive scenarios, market scenarios, and macroeconomic scenarios. In an example, the scenarios may be considered as competitive when the CLV of a business/product gets impacted due to business strategies or products of competitors. In another example, the scenarios may be considered as macroeconomic scenarios when the factors may include inflation, unemployment, and other economic factors. Therefore, the framework 100 facilitates in enabling organizations to identify such factors based on which the organizations or firms may strategize how to hold back the customers. The identified scenario model and the base model can be combined to determine a consolidated CLV for the business in a given market scenario.

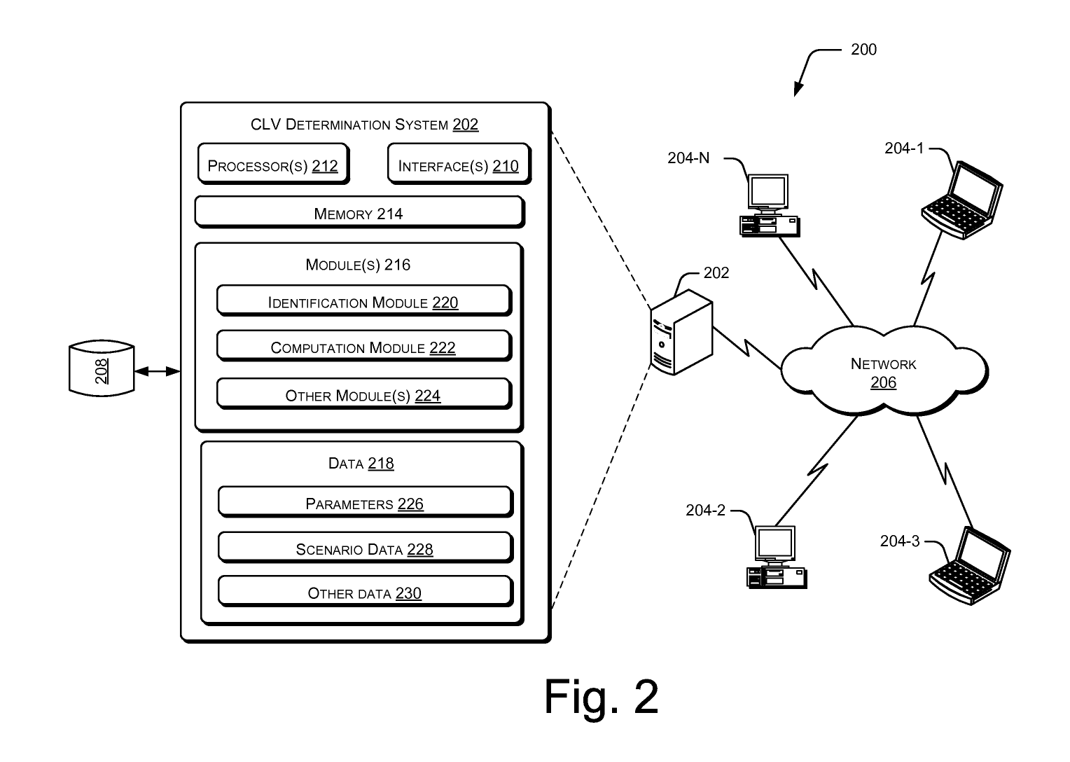

Furthermore, the framework 100 is implemented in a CLV determination system, according to an implementation of the present subject matter. In said implementation, the CLV determination system can be configured to identify the CLV for a specific business, based on the framework 100. The CLV determination system is described in detail with reference to FIG. 2.

FIG. 2 illustrates a network environment 200 implementing a CLV determination system 202, in accordance with an embodiment of the present subject matter. In said embodiment, the network environment 200 includes the CLV determination system 202 configured to identify the CLV for a business based on the framework 100. The framework 100 classifies different businesses into eight groups based on different combination of three parameters, namely time, count, and duration. The framework 100 also associates each group with a CLV base model to identify the CLV of the business falling under that group.

In one implementation, the network environment 200 may be a company network, including thousands of office personal computers, laptops, various servers, such as blade servers, and other computing devices. Examples of a company may include an information technology (IT) company, a product manufacturing company, a human resource (HR) company, a telecommunication company, or other large conglomerates. It will also be appreciated by a person skilled in the art that the company may be any company involved in any line of business. In another implementation, the network environment 200 may be a smaller private network. In yet another implementation, the network environment 200 may be a public network, such as a public cloud.

The CLV determination system 202 may be implemented in a variety of computing systems, such as a laptop computer, a desktop computer, a notebook, a workstation, a mainframe computer, a server, a network server, and the like. In one implementation, the CLV determination system 202 may be included within an existing information technology infrastructure or a database management structure. Further, it will be understood that the CLV determination system 202 may be connected to a plurality of user devices 204-1, 204-2, 204-3, . . . , 204-N, collectively referred to as the user devices 204 or as an individual user device 204. The user device 204 may include, but is not limited to, a desktop computer, a portable computer, a mobile phone, a handheld device, and a workstation. The user devices 204 may be used by users, such as database analysts, programmers, developers, data architects, software architects, module leaders, projects leaders, database administrator (DBA), stakeholders, and the like.

As shown in the figure, the user devices 204 are communicatively coupled to the CLV determination system 202 over a network 206 through one or more communication links for facilitating one or more end users to access and operate the CLV determination system 202. In one implementation, the network 206 may be a wireless network, a wired network, or a combination thereof. The network 206 may also be an individual network or a collection of many such individual networks, interconnected with each other and functioning as a single large network, e.g., the Internet or an intranet. The network 206 may be implemented as one of the different types of networks, such as intranet, local area network (LAN), wide area network (WAN), the internet, and such. The network 206 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 206 may include a variety of network devices, including routers, bridges, servers, computing devices, storage devices, and the like.

In an implementation, the CLV determination system 202 may be coupled to a database 208. Although not shown in the figure, it will be understood that the database 208 may also be connected to the network 206 or any other network in the network environment 200. In an implementation, the database 208 may include various input files containing the framework 100 that may be referred by the CLV determination system 202. In an implementation, the database 208 may be provided as a relational database and may store data in various formats, such as relational tables, object oriented relational tables, indexed tables. However, it will be understood that the database 208 may be provided as other types of databases, such as operational databases, analytical databases, hierarchical databases, and distributed or network databases.

The CLV determination system 202 further includes interface(s) 210. The interface(s) 210 may include a variety of software and hardware interfaces, for example, interfaces for peripheral device(s), such as a keyboard, a mouse, an external memory, and a printer. Additionally, the interface(s) 210 may enable the CLV determination system 202 to communicate with other devices, such as web servers and external repositories. The interface(s) 210 may also facilitate multiple communications within a wide variety of networks and protocol types, including wired networks, for example, LAN, cable, etc., and wireless networks, such as WLAN, cellular, or satellite. For the purpose, the interface(s) 210 may include one or more ports.

In an implementation, the CLV determination system 202 includes a processor(s) 212 coupled to a memory 214. The processor(s) 212 may be implemented as one or more microprocessors, microcomputers, microcontrollers, digital signal processors, central processing units, state machines, logic circuitries, and/or any devices that manipulate signals based on operational instructions. Among other capabilities, the processor(s) 212 may be configured to fetch and execute computer-readable instructions stored in the memory 214.

The memory 214 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the CLV determination system 202 includes module(s) 216 and data 218. The module(s) 216 include, for example, an identification module 220, a computation module 222, and other module(s) 224. The other module(s) 224 may include programs or coded instructions that supplement applications or functions performed by the CLV determination system 202.

The data 218 may include parameters 226, scenario data 228, and other data 230. The other data 230, amongst other things, may serve as a repository for storing data that is processed, received, or generated as a result of the execution of one or more modules in the module(s) 216. Although the data 218 is shown internal to the CLV determination system 202, it may be understood that the data 218 can reside in an external repository (not shown in the figure), which may be coupled to the CLV determination system 202. The CLV determination system 202 may communicate with the external repository through the interface(s) 210 to obtain information from the data 218.

As mentioned above, the present subject matter relates to a framework for determining CLV of different businesses. The framework is based on parameters of time, count, and duration. Based on different combinations of these parameters, the framework may classify the businesses into different groups. Further, the framework may define a CLV base model for each of the group of parameters. This may facilitate in identifying the CLV for any kind of business. Furthermore, such a classification may provide one CLV base model for the businesses following under one group.

In an implementation, the identification module 220 may be configured to receive inputs from a user based on the three parameters. The user may provide the details as per the business in consideration. For example, for a magazine business, the user may select the parameters as follows: time as certain, count as low, and duration as fixed. The identification module 220 may be configured to identify the CLV base model based on the combination of the parameters provided by the user. The identification module 220 may retrieve the CLV base model from the database 208. It will be evident to a person skilled in the art that the framework 100 will be stored in the database 208. The identification module 220 may further be configured to store the parameters selected by the user as the parameters 226.

In another implementation, the identification module 220 may be configured to identify the CLV base model that may be applicable for a business by simply providing details of a business. For example, the user may provide details of the business, such as a direct-to-home (DTH) service. The identification module 220 may be configured to facilitate the user in identifying a value of the parameters that may be relevant for the business. For example, the user may select the value for time from certain or uncertain based on the transactions that occur in the business. Further, the user may select the value of count based on a frequency of occurrence of the transactions. The identification module 220 may also facilitate the user to select whether the overall duration of the business is fixed or open. Based on these selections, the identification module 220 may identify the corresponding CLV base model for a business.

In an embodiment of the present subject matter, the framework 100 may facilitate in identifying different market scenarios that may impact consumer buying behaviour and therefore the CLV. Generally, there are four factors that impact a business. For example, the four factors may include changes in product/services offered by a firm or by its competitors (including price and other attributes); changes in distribution of these products; changes in economic conditions under which the firms operate; and extent to which customers' may part away with their disposable income with a given business. To help businesses strategically address these four factors and for ease of implementation, the present subject matter describes seven business scenarios, based on these four factors, that may impact CLV.

In each scenario, for every combination of parameters, the framework 100 may provide a consolidated CLV. The consolidated CLV may be understood as the CLV calculated from the CLV base model and at least one CLV scenario model that may be associated with the CLV base model. In one implementation, the scenario model(s) employed for the scenarios may be selected from models known in the art. Thus, the systems and methods described herein provide for determination of CLV related to a business based on one or more scenarios using the identified base model and scenario model. For example, a first scenario may include identifying a potential customer value. The framework 100 may include a model for each scenario and the identification module 220 may be configured to identify and retrieve the CLV base model and at least one CLV scenario model for a specified scenario. The below mentioned table describes the CLV calculation model for a potential customer value scenario, i.e., scenario 1.

TABLE 3
Scenario Model Selection for Scenario 1

| | DIMENSIONS | | | SCENARIO BASED MODELLING |
|---|---|---|---|---|
| GROUPS | TIME | COUNT | DURATION | APPROACH |
| A | Certain | High | Fixed | Logit model for both cross/up sell and |
| | | | | renewal of product |
| B | Certain | High | Open | Logit model for both cross/up sell and |
| | | | | renewal of product |
| C | Certain | Low | Open | Logit model for both cross/up sell and |
| | | | | renewal of product |
| D | Certain | Low | Fixed | Logit model for both cross/up sell and |
| | | | | renewal of product |
| E | Uncertain | High | Fixed | Headroom analysis |
| | | | | Logit model for renewal |
| F | Uncertain | High | Open | Headroom analysis |
| | | | | Logit model for renewal |
| G | Uncertain | Low | Open | Headroom analysis |
| | | | | Customer loyalty model |
| H | Uncertain | Low | Fixed | Headroom analysis |
| | | | | Customer loyalty model |

As may be understood from table 3, the framework 100 includes at least one CLV scenario model for calculation of the consolidated CLV for a combination of parameters. In an implementation, for the scenario of potential customer value, the consolidated CLV may be computed by adding a value received from the Logit model to the CLV base model. The Logit model may be used for cross-sell, up-sell, and renewal of a product. The Logit model may be understood as a binary model which provides two possible outcomes of a dependent variable. The Logit model utilizes past information and may formulate a functional relationship between the dependent and independent variables. The Logit model may facilitate in predicting the dependent variable when the value of the independent variable is provided.

In another implementation, for computing the consolidated CLV headroom analysis technique may be used along with the Logit model by the framework 100. The Headroom analysis may be understood as a planning allowance that a company should take into account when developing plans to balance supplies and demand and to deliver desired level of service. Further, the customer loyalty model may include analyzing the affinity of a customer towards a product that may be desirable over the other. For example, the analysis may be based on attitude of a customer, reliability of a product or a service, technology, and supplier's culture.

Considering another scenario, scenario 2, for determining impact of introduction of new product/services on CLV, the framework 100 may employ market share model along with a customer loyalty model for computing the consolidated CLV for a combination of the parameters. Table 4 indicates which groups of business may use the market share model and/or the customer loyalty model for computation of the consolidated CLV.

TABLE 4
Scenario Model Selection for Scenario 2

| | | | | SCENARIO BASED |
|---|---|---|---|---|
| | DIMENSIONS | | | MODELLING |
| GROUPS | TIME | COUNT | DURATION | APPROACH |
| A | Certain | High | Fixed | Based on the market |
| | | | | share of the product |
| B | Certain | High | Open | Based on the market |
| | | | | share of the product |
| C | Certain | Low | Open | Based on the market |
| | | | | share of the product |
| D | Certain | Low | Fixed | Based on the market |
| | | | | share of the product |
| E | Uncertain | High | Fixed | Customer loyalty |
| | | | | model |
| F | Uncertain | High | Open | Customer loyalty |
| | | | | model |
| G | Uncertain | Low | Open | Customer loyalty |
| | | | | model |
| H | Uncertain | Low | Fixed | Customer loyalty |
| | | | | model |

The market share model may be used to calculate market share of a product before and after introduction of a new product. Further, the customer loyalty model may include analyzing the affinity of a customer towards a product desirable over the other. For example, the analysis may be based on attitude of a customer, reliability of a product or a service, technology, and supplier's culture. It will be evident to a person skilled in the art that for each combination of the parameters the CLV base model is same as that mentioned in Table 2 above.

The third scenario, scenario 3, may be based on impact of removal of existing product/services on CLV. As is illustrated in table 5 below, the framework 100 employs nested Logit model and Markov chain model for computation of the consolidated CLV.

TABLE 5
Scenario Model Selection for Scenario 3

| | | | | SCENARIO BASED |
|---|---|---|---|---|
| | DIMENSIONS | | | MODELLING |
| GROUPS | TIME | COUNT | DURATION | APPROACH |
| A | Certain | High | Fixed | Nested Logit model |
| B | Certain | High | Open | Nested Logit model |
| C | Certain | Low | Open | Markov chain model |
| D | Certain | Low | Fixed | Markov chain model |
| E | Uncertain | High | Fixed | Nested Logit model |
| F | Uncertain | High | Open | Nested Logit model |
| G | Uncertain | Low | Open | Markov chain model |
| H | Uncertain | Low | Fixed | Markov chain model |

The table 5 above includes the nested logit model that may capture alternative choices by partitioning them in nests, as is well understood. Further, the markov chain model may be used for predicting a future course of action based on a current state. For example, the Markov chain model may be used in predicting probability of brand switching for a customer which may provide a value in calculating CLV when there is low count of transaction happening.

The framework 100 may define market scenarios, scenario 4 that may be based on effect on CLV for a permanent change in product and/or services price and scenario 5 that may be based on effect on CLV for a permanent change in product and/or services attributes. As is illustrated in table 6 below, the framework 100 employs VAR model and elasticity model for computation of the consolidated CLV.

TABLE 6
Scenario Model Selection for Scenario 4 and Scenario 5

| | | | | SCENARIO BASED |
|---|---|---|---|---|
| | DIMENSIONS | | | MODELLING |
| GROUPS | TIME | COUNT | DURATION | APPROACH |
| A | Certain | High | Fixed | VAR model |
| B | Certain | High | Open | VAR model |
| C | Certain | Low | Open | Elasticity model |
| D | Certain | Low | Fixed | Elasticity model |
| E | Uncertain | High | Fixed | VAR model |
| F | Uncertain | High | Open | VAR model |
| G | Uncertain | Low | Open | Elasticity model |
| H | Uncertain | Low | Fixed | Elasticity model |

The table 6 above includes the VAR model that may be useful for describing the dynamic behavior of economic and financial time series. The VAR model may also be used for forecasting about the CLV. Further, the elasticity model measures the percentage reaction of a dependent variable to a percentage change in an independent variable. This model takes into account the flexibility in consumer's behavior for a relative change in product prices or attributes.

The framework 100 may further facilitate computation of the consolidated CLV for a scenario, scenario 6, that considers effect of change in distribution & channel on the CLV. For this scenario, the framework 100 utilizes information regarding the distribution & channel of a product or a service that is received from a user.

TABLE 7
Scenario Model Selection for Scenario 6

| | | | | SCENARIO BASED |
|---|---|---|---|---|
| | DIMENSIONS | | | MODELLING |
| GROUPS | TIME | COUNT | DURATION | APPROACH |
| A | Certain | High | Fixed | Information regarding |
| B | Certain | High | Open | the distribution & |
| C | Certain | Low | Open | channel of the product |
| D | Certain | Low | Fixed | or services to be |
| E | Uncertain | High | Fixed | gathered from the user |
| F | Uncertain | High | Open | |
| G | Uncertain | Low | Open | |
| H | Uncertain | Low | Fixed | |

Further, table 8 indicates the CLV base models for a scenario, scenario 7, to determine macro-economic impact on the CLV. As may be seen in the below table, the framework 100 utilizes VAR model and impulse response (IR) analysis for calculating the consolidated CLV for each group of the framework 100.

TABLE 8
Scenario Model Selection for Scenario 7

| | | | | SCENARIO BASED |
|---|---|---|---|---|
| | DIMENSIONS | | | MODELLING |
| GROUPS | TIME | COUNT | DURATION | APPROACH |
| A | Certain | High | Fixed | VAR model & IR |
| | | | | analysis |
| B | Certain | High | Open | VAR model & IR |
| | | | | analysis |
| C | Certain | Low | Open | VAR model & IR |
| | | | | analysis |
| D | Certain | Low | Fixed | VAR model & IR |
| | | | | analysis |
| E | Uncertain | High | Fixed | VAR model & IR |
| | | | | analysis |
| F | Uncertain | High | Open | VAR model & IR |
| | | | | analysis |
| G | Uncertain | Low | Open | VAR model & IR |
| | | | | analysis |
| H | Uncertain | Low | Fixed | VAR model & IR |
| | | | | analysis |

It will be appreciated by a skilled person that the IR analysis may be helpful in describing reaction of various macro-economic variables such as consumption due to sudden change in consumer taste or other factors which may be unexplained.

In an implementation, the computation module 222 may be configured to compute the CLV associated with a base model that may be identified by the identification module 220. Further the computation module 222 may be configured to compute the CLV associated with the different scenario models for the business. The computation module 222 may then provide the consolidated CLV for each business in each of the scenario defined by the framework 100. The consolidated CLV for a particular scenario may be understood as the combination, for example, a sum, of the CLV associated with the base model and the CLV associated with the particular scenario.

Further, based on the seven market scenarios, the framework 100 facilitates in obtaining the consolidated CLV for a best case CLV, a most probable CL, and a worst case CLV. For example, the consolidated CLV having the highest value may be identified as the best case CLV. The consolidated CLV having the lowest value may be identified as the worst case CLV. An average of the consolidated CLVs may be identified as the most probable CLV. For this, the framework 100 refers to the consolidated CLV that may be derived for the above-mentioned seven market scenarios.

In another implementation, the identification module 220 may be configured to identify a CLV scenario model applicable to the business based on user inputs and the computation module 222 may compute the consolidated CLV based on the at least one CLV scenario model identified by the identification module 220.

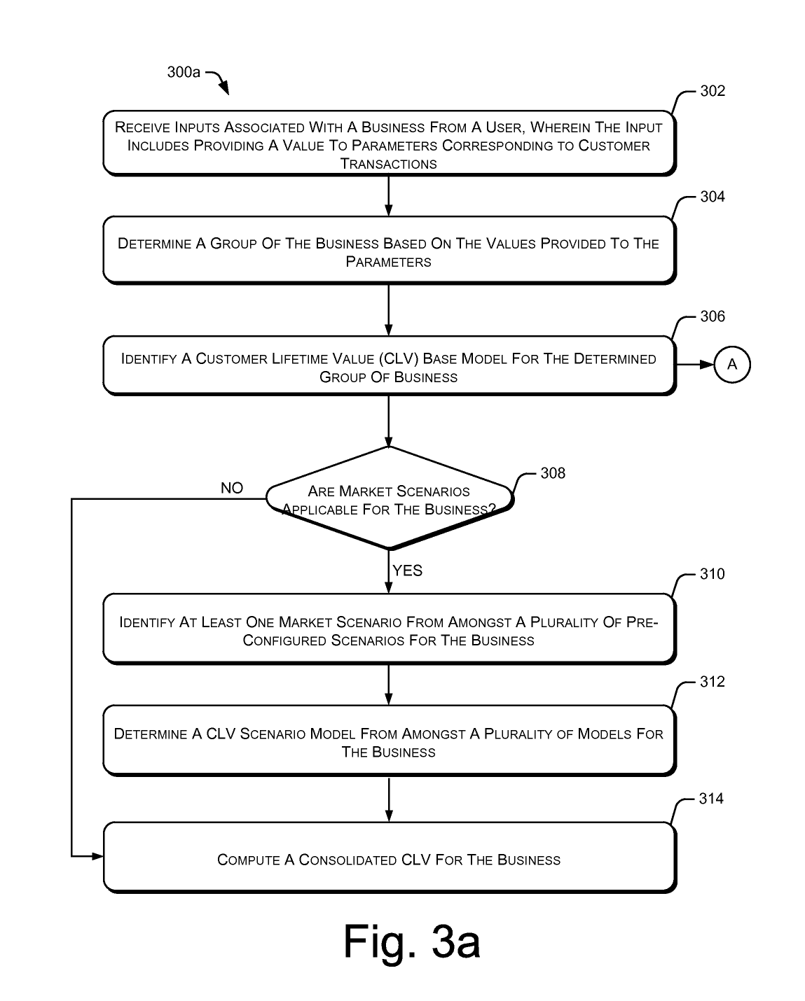

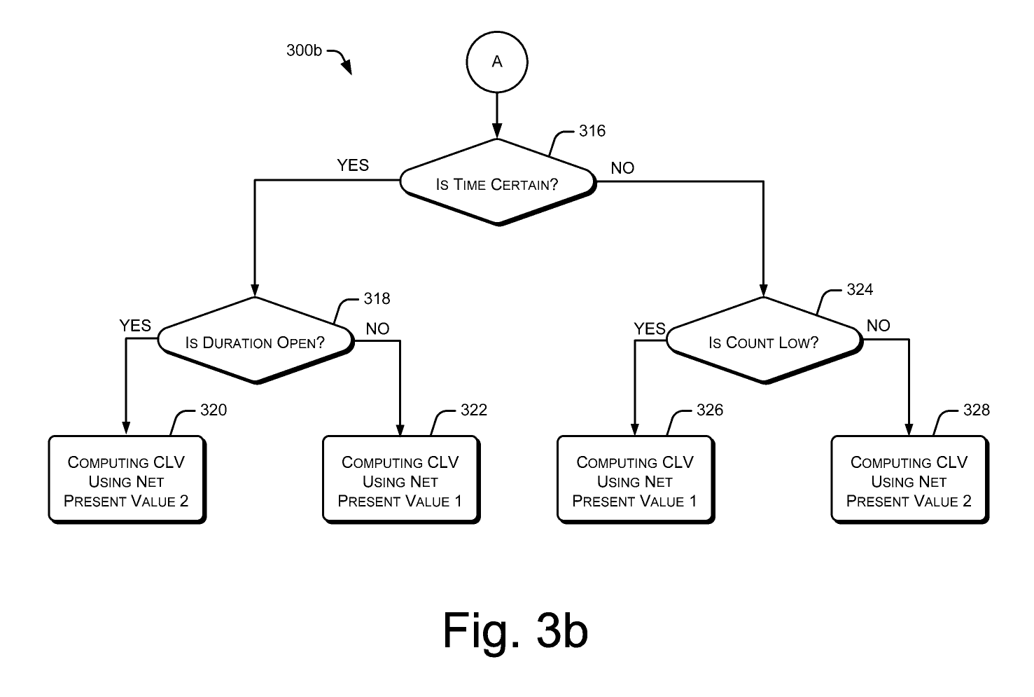

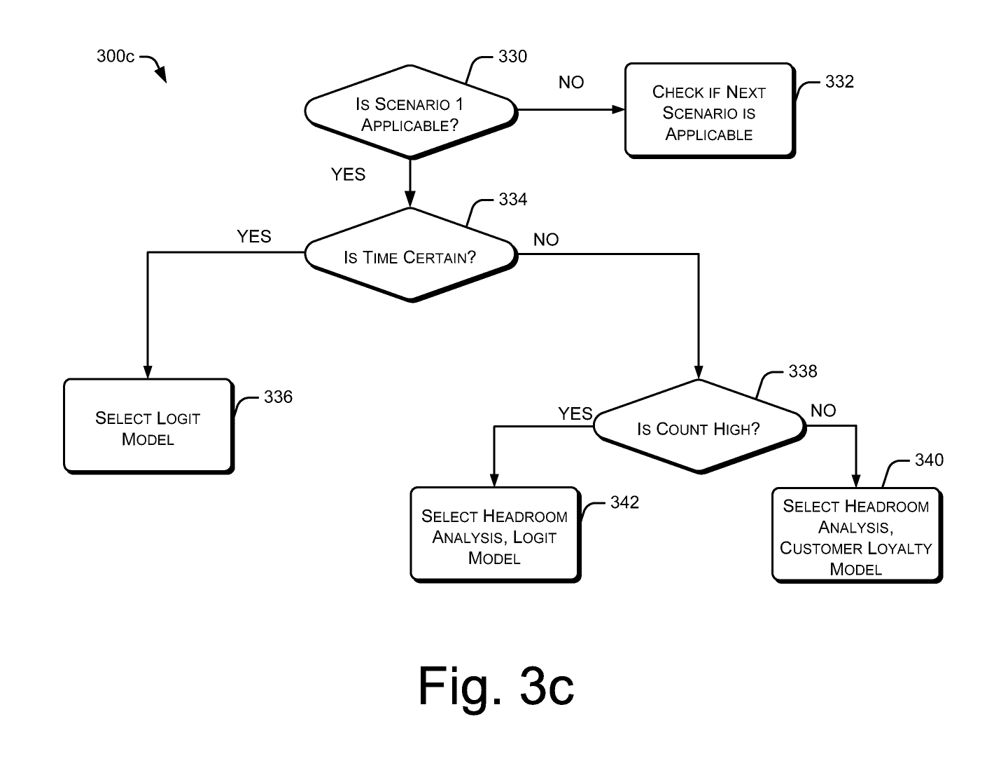

FIG. 3a illustrates a method 300a for computing a consolidated CLV for a business in a specific scenario in accordance with an embodiment of the present subject matter, whereas FIG. 3b illustrates a method 300b for determining a CLV base model for a particular business, in accordance with an embodiment of the present subject matter. Further, FIG. 3c illustrates a method 300c for determining a CLV scenario model for a particular business, in accordance with an embodiment of the present subject matter.

The methods 300a, 300b and 300c may be described in the general context of computer executable instructions. Generally, computer executable instructions can include routines, programs, objects, components, data structures, procedures, modules, functions that perform particular functions or implement particular abstract data types. The methods 300a, 300b and 300c may also be practiced in a distributed computing environment where functions are performed by remote processing devices that are linked through a communication network. In a distributed computing environment, computer executable instructions may be located in both local and remote computer storage media, including memory storage devices.

The order in which the methods 300a, 300b and 300c are described is not intended to be construed as a limitation, and some of the described method blocks can be combined in any order to implement the methods 300a, 300b and 300c or alternative methods. Additionally, some of the individual blocks may be deleted from the methods 300a, 300b and 300c without departing from the spirit and scope of the subject matter described herein. Furthermore, the methods 300a, 300b and 300c can be implemented in any suitable hardware, software, organization ware, or combination thereof.

Referring to FIG. 3a, at block 302, the method 300a may include receiving inputs associated with a business from a user. The inputs facilitate in determining a group in which a business lies. The input includes providing a value to parameters corresponding to customer transactions. In an implementation, the framework 100 may include eight groups of businesses based on three parameters, such as time, count, and dimension. Each of the eight groups may be based on different combinations of the three parameters. Accordingly, the inputs received from the user may include a value for each of three parameters. For example, the three parameters may include time, count, and duration and the user may provide values to each of the three parameters. The user may select a value from certain or uncertain for the time parameter, low or high for the count parameter, and fixed and open for the duration parameter.

Further, at block 304, the method 300a may include determining a group from amongst a plurality of groups, in which the business lies. As mentioned above, the group of the business may be determined based on the values provided to the three parameters. In an implementation, the identification module 220 may be configured to determine the group associated with a business in consideration.

At block 306, the method 300a may include identifying a CLV base model that may be applicable for the determined business based on the combination of the values for the three parameters. Accordingly, the identification module 220 may be configured to identify a group in which a business lies. Considering an example where the user has provide time as uncertain, count as high, and duration as fixed. In this example, the identification module 220 may be configured to identify the CLV base model as,

$$CLV = {\sum }_{t = 0}^{T} \frac{{P}_{t}}{{( 1 + d )}^{t}} * {P}_{np}$$

It will be evident that the CLV base model may be retrieved from the framework 100 that may be stored in a database 208. Therefore, the identification module 220 may be configured to retrieve a CLV base model that may be applicable for a given combination of the three parameters.

At block 308, the method 300a may include determining whether any market scenario is applicable for the determined business. The market scenarios are defined by the framework 100. If any market scenario is applicable for the business, the method 300 may progress to block 310. If any market scenario is not applicable for the business, the method 300 may move to block 314.

At block 310, the method 300a may include identifying at least one market scenario from amongst a plurality of market scenarios based on different factors that may impact the CLV. In an implementation, the plurality of scenarios may include competitive scenarios, market scenarios, and macro-economic scenarios. The identification module 220 may be configured to determine the plurality of market scenarios for a business. The identification module 220 may further be configured to store the scenarios as scenario data 228.

At block 312, the method 300a may include determining at least one CLV scenario model that may be employed by the framework 100 for calculating the CLV for each group in a specific scenario. In an implementation, the identification module 220 may be configured to identify the at least one CLV scenario model from a Logit model, a Headroom analysis, a Customer loyalty model, a Market share model, a nested Logit model, a Markov chain model, a Vector Auto-Regressive model, an Elasticity model, an Impulse response (IR) model, and combination thereof.

At block 314, the method 300a may include computing a consolidated CLV for the business for each of the plurality of scenarios. In an implementation, the computation module 222 may be configured to compute the consolidated CLV for the business in consideration. The computation module 222 may be configured to evaluate the CLV scenario model and add a value from the evaluation in the CLV obtained from the CLV base model. In an implementation, if none of the plurality of scenarios is deemed to be fit for the business, the CLV obtained through the CLV base model may be considered as the consolidated CLV.

Referring to FIG. 3b, the CLV base model may be determined for a business under consideration. As described earlier, the CLV base model may be determined based on the user inputs provided on the plurality of parameters.

At block 316, the method 300b may include determining whether transaction time for the business is certain or uncertain. If the time is certain, the method 300b moves to block 318. If the time is uncertain, the method 300b moves to block 324.

At block 318, the method 300b may include determining whether the duration of transaction is open or not. If the duration is open, the method 300b moves to block 320. If the duration is fixed, the method 300b moves to block 322. In an implementation, the identification module 220 may be configured to determine the value of time and duration.

At block 320, the method 300b may include computing the CLV for the business using net present value for an indefinite time frame, using the below mentioned formula:

$${\sum }_{t = 0}^{∞} \frac{{Profit}_{t}}{{( 1 + discount )}^{t}}$$

At block 322, the method 300 may include computing the CLV for the business using net present value for a fixed time frame, using the below mentioned formula:

$${\sum }_{t = 0}^{T} \frac{{Profit}_{t}}{{( 1 + discount )}^{t}}$$

Further, at block 324, the method 300b may include determining whether the count of transaction is low or high. If the count is low, the method 300b moves to block 326. If the count is high, the method 300b moves to block 328. In an implementation, the identification module 220 may be configured to determine the value of count.

At block 326, the method 300b may include computing the CLV for the business using net present value for fixed time frame, using the below mentioned formula:

$${\sum }_{t = 0}^{T} \frac{{Profit}_{t}}{{( 1 + discount )}^{t}}$$

At block 328, the method 300 may include computing the CLV for the business using net present value for an indefinite time frame, using the below mentioned formula:

$${\sum }_{t = 0}^{∞} \frac{{Profit}_{t}}{{( 1 + discount )}^{t}}$$

In an implementation, the computation module 222 may be configured to compute the CLV for the business using net present value for an indefinite time frame as well as for a fixed time frame.

Further, as mentioned earlier, for computing the consolidated CLV, either at least one applicable scenario model may be identified or the consolidated CLV may be computed based on all the scenario models.

FIG. 3c illustrates the method 300c for determining a CLV scenario model for a particular business for potential customer value scenario, i.e., scenario 1, in accordance with an embodiment of the present subject matter. For ease of understanding, gig. 3c can be understood with reference to Table 3—Scenario Model Selection for Scenario 1, described above. It will be understood that, in one implementation, the method 300c can be performed by the identification module 220.

At block 330, the method 300c includes determining if the potential customer value scenario is applicable based on user inputs. If the potential customer value scenario is not applicable, then the method 300c proceeds to block 332, where the applicability of next scenario is checked and accordingly the CLV scenario model is identified.

On the other hand, if the potential customer value scenario is applicable, the method 300c proceeds to block 334, where it determines if Time parameter is certain, i.e., whether there is certainty about the time at which the CLV generating transaction takes place. If the time is certain, then at block 336, the Logit model is selected as the applicable scenario model for the business. Thus, as is seen in Table 3 above, the Logit model is selected for groups A, B, C, and D, where time is certain.

If the time is not certain, then the method proceeds to block 338 from block 334. At block 338 it is determined if the count is high. If the count is not high, then at block 340, Headroom analysis based on Customer loyalty model is selected as the scenario model, as shown for groups G and H in Table 3. Whereas, if the count is high, then at block 342, Headroom analysis based on Logit model for renewal is selected as the scenario model, as shown for groups E and F in Table 3.

It will be appreciated that similarly, other methods may be used for determining scenario models to select the scenario model for a business for different scenarios as given in Tables 4-8.

For example, for the scenario 2 related to impact of introduction of new products/services on CLV, as shown in Table 4, if the scenario is applicable, it can be determined if the time is certain. As shown for groups A, B, C, and D in Table 4, if the time is certain, then the scenario model selected is based on market share of the product. On the other hand, if time is uncertain then customer loyalty model is used as shown for groups E, F, G, and H in Table 4.

Similarly, for the scenario 3 related to impact of removal of existing products/services on CLV, as shown in Table 5, if the scenario is applicable, it can be determined if the count is high. As shown for groups A, B, E, and F in table 5, if the count is high, then the Nested Logit model is selected as the scenario model. Whereas, if the count is low, then the Markov chain model is selected, as shown for groups C, D, G, and H in table 5.

Further, for scenarios 4 and 5 related to effect on CLV for a permanent change in product/services prices and attributes, as shown in Table 6, if any of the scenarios is applicable, it can be determined if the count is high. As shown for groups A, B, E, and F in table 6, if the count is high, then the VAR model is selected as the scenario model. Whereas, if the count is low, then the Elasticity model is selected, as shown for groups C, D, G, and H in table 6.

However, for scenario 6 related to effect of change in distribution/channels in CLV, as shown in Table 7, if the scenario is applicable, then information regarding the distribution and channel of the product or services are obtained from a user and applied to select the scenario model. For example, time series forecasting or other known forecasting methods can be employed based on the user inputs.

Furthermore, for scenario 7 related to macroeconomic impact, as shown in Table 8, if the scenario is applicable, then a combination of VAR model and Impulse response (IR) analysis is used as the scenario model.

It will be appreciated that, in the above description, the scenarios 1-7 are numbered for ease of reference and do not correspond to any order or priority of the scenarios. Thus, the identification module 220 of the CLV determination system 202 may identify a scenario model in any order and is not restricted to the order 1-7.

Although embodiments for determination of customer lifetime value have been described in language specific to structural features and/or methods, it is to be understood that the present subject matter is not necessarily limited to the specific features or methods described. Rather, the specific features and methods are disclosed as exemplary implementations for the customer lifetime value determination.

I/We claim:

1. A computer implemented method for determining a parameter indicative of a customer lifetime value (CLV) for a business, the method comprising:
receiving, from a user, inputs associated with a plurality of parameters, wherein the plurality of parameters correspond to customer transactions associated with the business;
determining, by an identification module, a CLV base model applicable for the business based on the received inputs, wherein the CLV base model is determined from amongst a plurality of pre-defined CLV base models;
identifying based on the determined CLV base model, by the identification module, at least one market scenario from amongst a plurality of pre-configured market scenarios for the business, wherein each of the plurality of pre-configured market scenarios are based on a combination of the plurality of parameters; and
computing, by a computation module, a consolidated CLV for the business based on the determined CLV base model and at least one identified market scenario model.

2. The method as claimed in claim 1, wherein the plurality of parameters comprises a time of transaction, a count of transaction, and a duration of transaction.

3. The method as claimed in claim 2, wherein the time of transaction is selected from a certain and an uncertain category, the count of transaction is selected from a low and a high category, and the duration of transaction is selected from a fixed and an open category.

4. The method as claimed in claim 1, wherein the plurality of pre-configured market scenarios comprises a potential customer value, introduction of new services on CLV, removal of existing services on CLV, permanent change in services price, permanent change in services attributes, change in distribution channels in CLV, and macro-economic changes.

5. The method as claimed in claim 4 further comprising identifying at least one of a best case CLV, a most probable CLV, and a worst case CLV for the business based on the plurality of pre-configured market scenarios.

6. The method as claimed in claim 1, wherein the plurality of pre-configured market scenarios are based on at least one of an internal factor, an economic factor, and a competitive factor.

7. A customer lifetime value (CLV) determination system comprising:
a processor;
an identification module coupled to the processor, the identification module configured to,
receive inputs from a user, wherein the inputs are associated with a plurality of parameters correspond to customer transactions;
determine, based on the received inputs, a CLV base model applicable for the business, wherein the CLV base model is determined from amongst a plurality of pre-defined CLV base models; and
identify at least one market scenario from amongst a plurality of pre-configured market scenarios for the business, wherein each of the plurality of pre-configured market scenarios are based on a combination of the plurality of parameters; and
a computation module coupled to the processor, the computation module configured to compute a consolidated CLV for the business based on the determined CLV base model and at least one identified CLV scenario model.

8. The CLV determination system as claimed in claim 7, wherein the CLV base model is determined from a pre-defined CLV framework amongst the plurality of pre-defined CLV base models.

9. The CLV determination system as claimed in claim 7, wherein the computation module is further configured to evaluate at least one of a best case CLV, a most probable CLV, and a worst case CLV, for the business based on the plurality of pre-configured market scenarios.

10. A computer readable medium having embodied thereon a computer program for executing a method for determining customer lifetime value (CLV) for a business, the method comprising:
receiving, from a user, inputs associated with a plurality of parameters, wherein the plurality of parameters pertain to transactions occurring with respect to the business;
determining, based on the received inputs, a CLV base model applicable for the business, wherein the CLV base model is determined from a pre-defined CLV framework amongst a plurality of pre-defined CLV base models;
identifying at least one scenario from amongst a plurality of pre-configured scenarios for the business, wherein each of the plurality of pre-configured market scenarios are based on a combination of the plurality of parameters; and
computing a consolidated CLV for the business based on the determined CLV base model and the at least one identified CLV scenario model.
